(19) United States
(12) Patent Application Publication
(10) Pub. No.: US 2012/0306124 A1
(43) Pub. Date: Dec. 6, 2012

(54) UV Curing of Embossed Structures

(75) Inventor: Joseph M. Panish, Littleton, MA (US)

(73) Assignee: ORACLE INTERNATIONAL CORPORATION, Redwood City, CA (US)

(21) Appl. No.: 13/150,356

(22) Filed: Jun. 1, 2011

(51) Int. Cl. B29C 35/10; B29C 35/08

(52) U.S. Cl. 264/495; 425/174.4

(57) ABSTRACT

A system for embossing a pattern on a storage tape component includes a storage tape component having a curable layer, an ultraviolet light source, and an embossing drum. The embossing drum has an exterior drum section and an interior cavity. The exterior drum section is transmissive to ultraviolet light and has an outer surface that contacts the curable layer. The outer surface includes a first pattern that is complementary to a second pattern to be formed on the storage tape component. The exterior drum section is rotatable about a center such that the storage tape component moves in concert with the outer drum section while the curable layer is cured by ultraviolet radiation emanating from the ultraviolet light source.

### BACKGROUND

1. Field

The present invention relates to optical tape information/data storage technology and in particular to methods for making optical tape.

2. Description of the Related Art

The ever expanding amount of digital data provides an impetus for the continuing development of high capacity storage solutions. Technologies that are suitable for these applications include optical tape, magnetic tape, and optical disks. Of these possibilities, optical tape technology is believed to provide the greater storage capacity.

The typical optical tape medium includes a base film such as polyethylene naphthalate (PEN) over-coated with multiple layers for recording digital data. A polymeric imprint layer is usually disposed over the base film. In one type of optical tape, the imprint layer is over-coated with a reflective metallic layer that is, in turn, over-coated with a sequence of dielectric layer, phase change layer, and dielectric layer. The actual data recording and reading occurs in the phase change layer. In a typical application, a pulsed laser beam is projected from an optical head assembly onto the optical tape thereby causing a phase change in the phase change layer that results in data being encoded therein. Data encoded onto the optical tape is also read with a laser with the reflective layer reflecting light to a detector. Moreover, optical tape usually includes optical servo marks embossed into the imprint layer along the length of the tape for operating with a servo control system for controlling the optical head. Although the current optical tape technology works reasonably well, there are a number of problems related to the polymeric imprint layer.

Prior art methods of forming an embossed imprint layer typically require that light pass through a base film from the backside. Therefore, the prior art methods require an additional step of coating this base-film backside which limits the selections of materials for the base film.

Accordingly, there is a need for new methods for forming the imprint layer used in optical tape media.

### SUMMARY OF THE INVENTION

The present invention solves one or more problems of the prior art by providing, in at least one embodiment, a system for embossing a pattern on a storage tape component. The system includes a storage tape component having a curable layer, an ultraviolet light source, and an embossing drum. The embossing drum has an exterior drum section and an interior cavity. The exterior drum section is transmissive to ultraviolet light and has an outer surface that contacts the curable layer. The outer surface includes a first pattern that is complementary to a second pattern to be formed on the storage tape component. The exterior drum section is rotatable about a center such that the storage tape component moves in concert with the outer drum section while the curable layer is cured by ultraviolet radiation emanating from the ultraviolet light source.

In another embodiment, a system for embossing a pattern on a storage tape component is provided. The system includes a tape supply for supplying the storage tape component, an ultraviolet light source, and an embossing drum. The storage tape component includes a curable layer, The embossing drum has an exterior drum section and an interior cavity. The exterior drum section is transmissive to ultraviolet light and has an outer surface that contacts the curable layer. The outer surface includes a first pattern that is complementary to a second pattern to be formed on the storage tape component. The exterior drum section is rotatable about a center such that the storage tape component moves in concert with the outer drum section while the curable layer is cured by ultraviolet radiation emanating from the ultraviolet light source.

In another embodiment, a method for forming an emboss pattern on a storage tape component having a curable layer disposed thereon is provided. The method of the present embodiment utilizes the systems set forth above. The method includes a step of contacting an embossing drum with the curable layer. Characteristically, the embossing drum has an exterior drum section and an interior cavity. The exterior drum section is transparent to ultraviolet light while the outer surface has a pattern that is complementary to an emboss pattern to be formed on the storage tape component. The exterior drum section is rotatable about a center such that the storage tape component moves in concert with the outer drum section. The method further includes a step of curing the curable layer with ultraviolet radiation emanating from the ultraviolet light source to form the embossed pattern on the storage tape component.

### BRIEF DESCRIPTION OF THE DRAWINGS

Exemplary embodiments of the present invention will become more fully understood from the detailed description and the accompanying drawing, wherein:

FIG. 1 is a cross sectional view of an optical tape medium incorporating an embodiment of an imprint layer;

FIG. 2 is a perspective view of an imprint layer incorporating an embodiment of an imprint layer;

FIG. 3 is a schematic illustration of a system for forming an optical tape medium;

FIG. 4 is a schematic illustration of an embossing assembly;

FIG. 5 is a front view of an embossing drum shown the pattern disposed thereon; and

FIG. 6 is a cross section of the exterior drum section.

### DETAILED DESCRIPTION OF THE INVENTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this invention pertains.

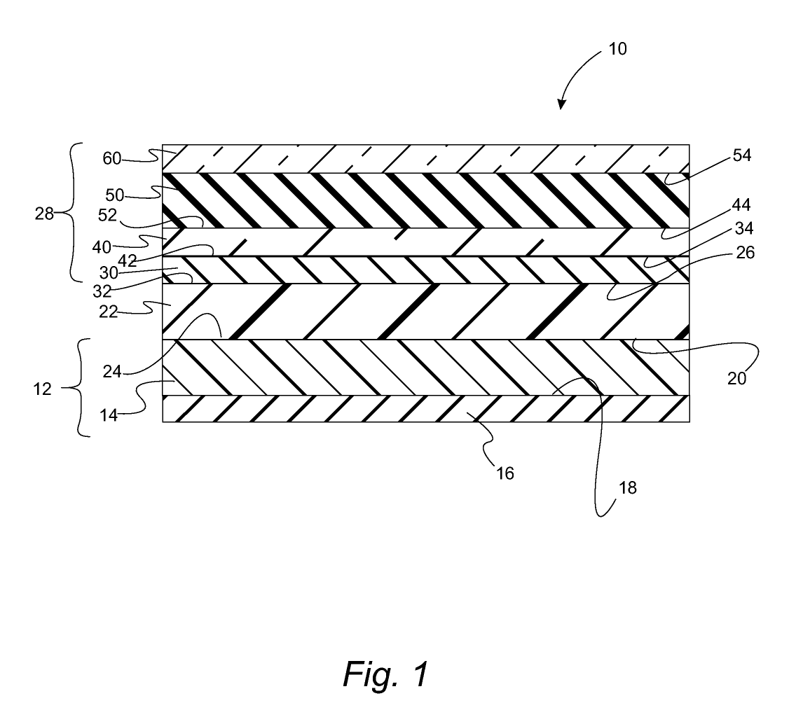

With reference to FIG. 1, a schematic illustration of an optical tape medium for storing digital data is provided. FIG. 1 is a cross sectional view of the optical tape medium. Optical tape 10 includes substrate 12. In a variation, substrate 12 includes base-film 14 and back-coating 16. Base-film 14 includes sides 18, 20. Typically, base-film 14 is formed from a polyester such as polyethylene naphthalate (PEN). Imprint layer 22 is disposed over side 20. In a refinement, imprint layer 22 contacts side 20. Imprint layer 22 includes imprint layer side 24 and imprint layer side 26 with imprint layer side 24 being more proximate to base-film 14. Advantageously, imprint layer 22 is made by the process set forth below. Multilayer data recording assembly 28 is disposed over imprint layer 22. Multilayer data recording assembly 28 typically includes one or more layers involved in the optical recording of data.

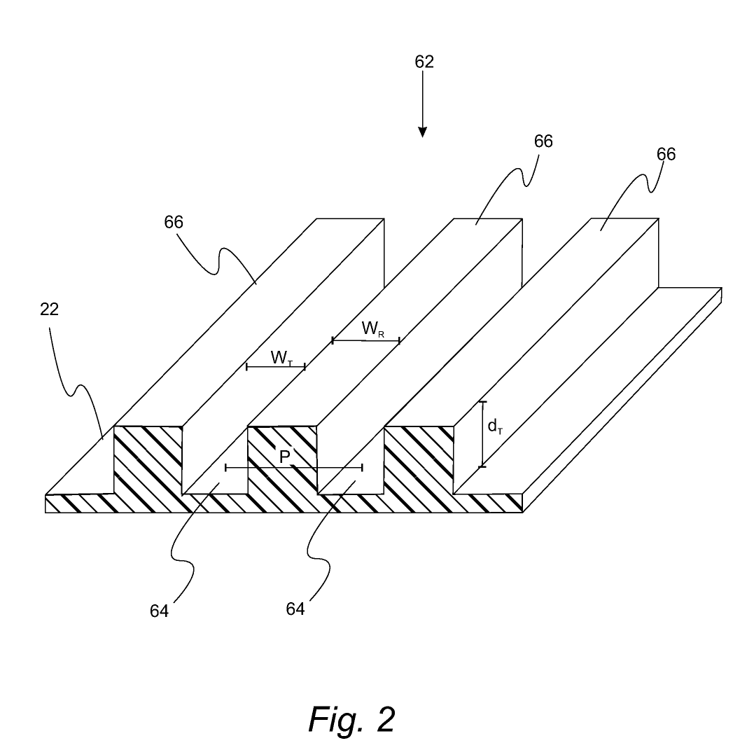

With reference to FIGS. 1 and 2, an example of multilayer data recording assembly 28 is provided. Multilayer data recording assembly 28 includes metal layer 30 disposed over imprint layer side 24. Metal layer 30 includes metal layer side 32 and metal layer side 34. Metal layer side 32 is more proximate to imprint layer 20 than metal layer side 34. Multilayer data recording assembly 28 also includes dielectric layer 40 disposed over metal layer side 34. Dielectric layer 40 includes dielectric layer side 42 and dielectric layer side 44 which is more proximate to metal layer 30. Multilayer data recording assembly 28 further includes phase change layer 50 which is disposed over dielectric layer 40. Phase change layer 50 includes phase change layer side 52 and phase change layer side 54 which is more proximate to phase change layer 50. Finally, the present embodiment also includes multilayer data recording assembly 28. Multilayer data recording assembly 28 also includes dielectric layer 60 disposed over metal layer side 54.

Still referring to FIG. 2, imprint layer 22 includes pattern 62 disposed therein. Pattern 62 includes a plurality of grooves 64 and ridges 66. Grooves 64 are characterized by trench with W_{T} and trench depth d_{T}. Typically, the trench depth is less than about 100 nanometers. Ridges 66 are characterized by ridge width W_{R}. The separation between the centers of the grooves is defined by the pitch P. In a refinement, the pitch is less than about 1 micron. Although FIG. 2 illustrates only a few tracks, it is generally understood that actual optical storage tapes include hundreds of thousands of tracks (i.e., about 150,000 tracks is typical). In a refinement, at least a portion of the tracks are wobbled.

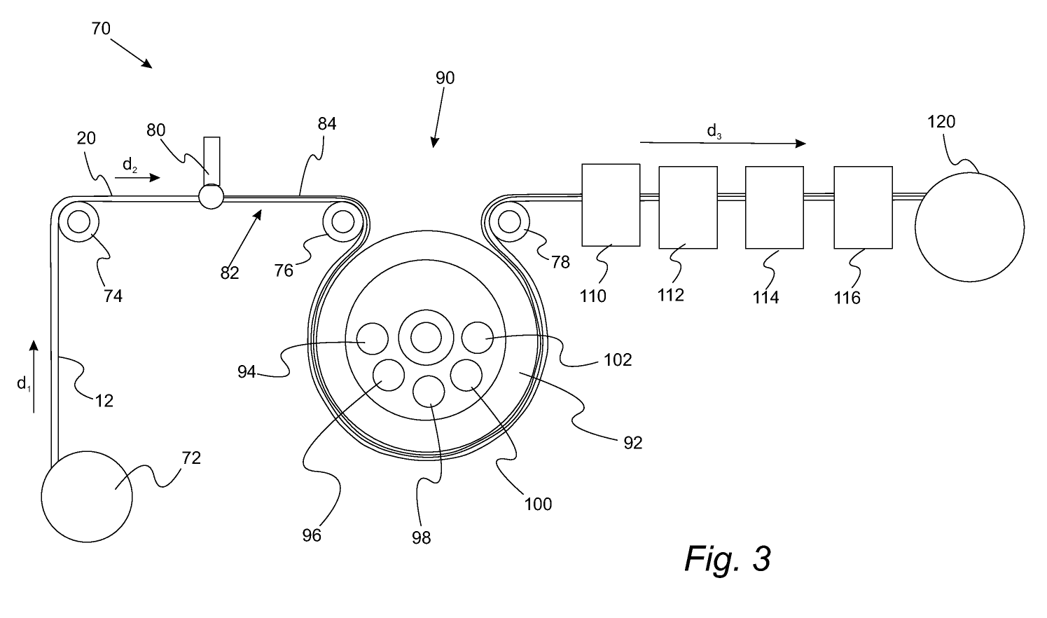

With reference to FIG. 3, a schematic diagram illustrating the fabrication of the optical storage medium set forth above is provided. Optical tape-forming system 70 includes spool 72 which supplies substrate 12 which is of a tape-like configuration. During operation of optical tape-forming system 70, substrate 12 moves in the directions indicated by d₁-d₃ and is guided by direction rollers 74-78. Substrate 12 is a component of an optical storage tape. In a refinement, substrate 12 (and the final storage tape) has a width from about 5 to about 24 inches. Base-film side 20 of substrate 12 is coated with a curable liquid composition from dispenser 80. In a refinement, the curable liquid composition includes a free radical photoinitiator and at least one polymerizable monomer, oligomer, or combinations thereof. Coated substrate film 82 includes curable liquid layer 84 which is disposed on substrate 12. Coated substrate film 82 proceeds to embossing assembly 90. Embossing assembly 90 includes patterning roller 92. Patterning roller 92 includes a pattern that is complementary to the pattern to be embossed onto coated substrate film 82. Curing energy sources 94-102 direct actinic radiation onto curable liquid layer 84 to induce polymerization therein to form imprint layer 20. Typically, curing energy sources 94-102 are ultraviolet (“UV”) light sources. Although any type of UV light source may be used, UV light emitting diodes (LED) have been found to be particularly useful. In a refinement, the UV light sources emit radiation in the range 380 to 450 nanometers with an intensity from 6 to 9 mJ/cm². Table 1 provides several useful dosing parameters. After curing, imprint layer 20 has a pattern imprinted therein.

TABLE 1
Wavelength and dosing combinations.

| LED Wavelength (nm) | Curing Dose (mJ/cm²) |
|---|---|
| 365 | 3.7 |
| 375 | 4.6 |
| 400 | 6.8 |
| 415 | 7.8 |

Still referring to FIG. 3, multilayer data recording assembly 28 is fabricated along direction d₃. In a variation, metal deposition station 110 is used to deposit metal layer 30 over imprint layer 20. Examples of deposition processes that may be used include sputtering and evaporation. Typically, metal deposition 110 is a sputtering reactor. Substrate film 12 proceeds next, to dielectric deposition station 112 to form dielectric layer 40. Phase change layer 50 is coated onto dielectric layer 40 at phase change coating system 114. Typically, phase change layer 50 is a metal alloy which has significant optical and electrical differences between the amorphous and crystalline states. Dielectric layer 60 is deposited onto phase change layer 50 via dielectric deposition station 116. It should be appreciated that metal layer 30, dielectric layers 40, 60 and phase change layer 50 can be single or multilayer structures. For example, some layers use two or three sub-layers to provide better reflection control and long term stability. Finally, optical tape 10 is rolled onto spool 120. Advantageously, the optical tape formed by the present method is observed to have superior mechanical and thermal properties. In particular, the method allows for the imprint layer to be formed with a thickness less than about 2 microns. In another refinement, the imprint layer has a thickness less than about 1.5 microns. In still another refinement, the imprint layer has a thickness greater than from about 0.1 to about 0.5 microns. In yet another variation, the imprint layer has a thickness greater than about 0.2 microns. In yet another variation, the imprint layer has a thickness between 0.3 and 0.4 microns. In still other variations, the imprint layer has a thickness from about 0.1 to about 0.25 microns.

In some variations, the optical tape processing is paused after formation of the imprint layer. In this variation, the coated substrate may be rolled onto a spool for later processing. In other variations, the optical tape may be subjected to a slitting process in order to fit in a cartridge.

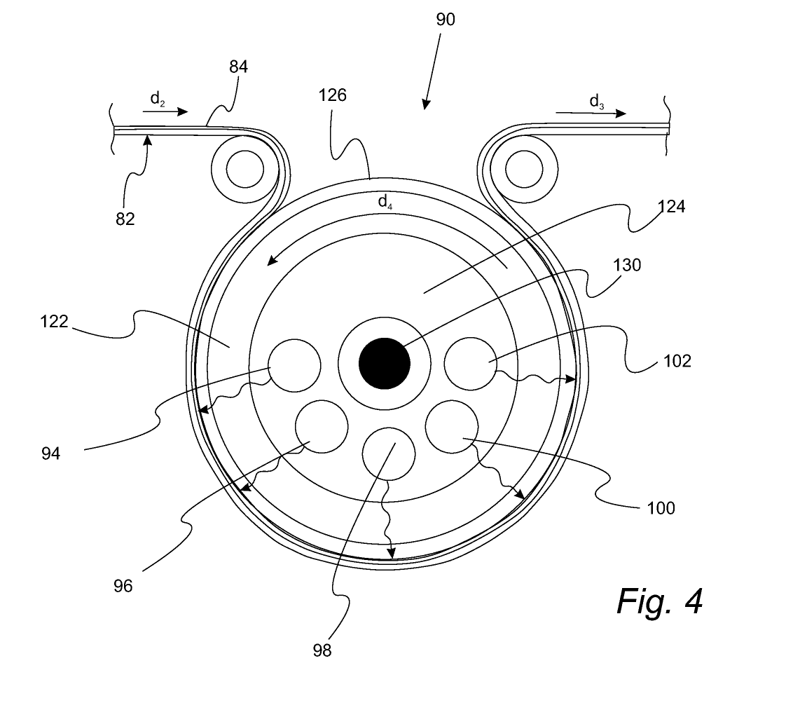

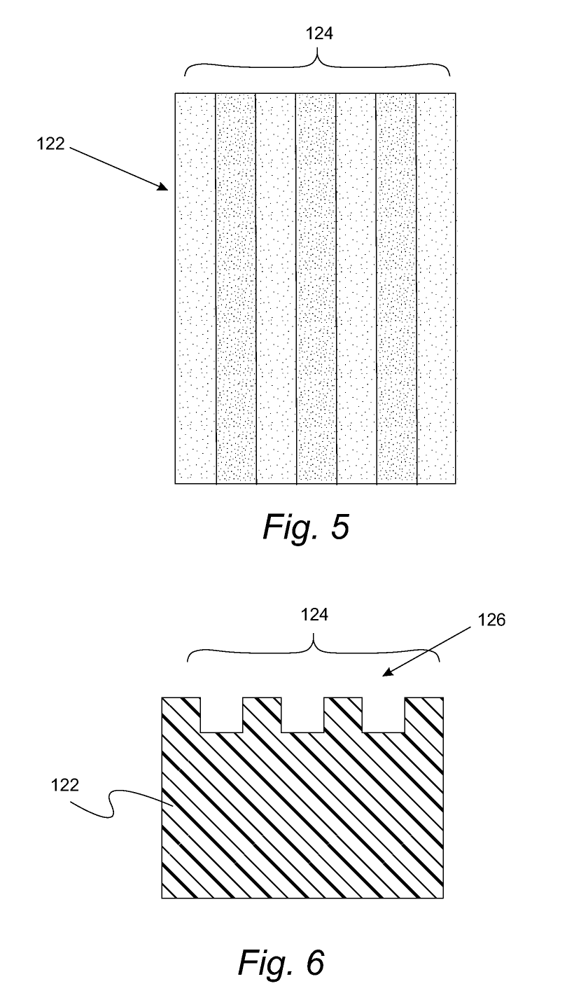

With reference to FIGS. 4, 5, and 6, details of the operation of embossing assembly 90 are provided. FIG. 4 is a schematic illustration of embossing assembly 90. FIG. 5 is a front view of embossing drum 92. FIG. 6 is a cross section of the exterior drum section. Embossing drum 92 includes exterior drum section 122 and interior cavity 124. In a refinement, embossing drum 92 has a width from about 4 to 10 inches and a length from about 5 to 30 inches. Characteristically, exterior drum section 122 is transmissive to ultraviolet light (UV). In order to accomplish such transparency, exterior drum section 122 is formed from quartz, UV transparent polymers, and combinations thereof. Exterior drum section 122 has pattern 124 disposed on surface 126. Pattern 124 is complementary to pattern 62 in imprint layer 22. In a refinement, pattern 124 is formed by laser etching of the pattern onto surface 124 of exterior drum section 122. Exterior drum section 122 is rotatable about center 130 along direction d₄ such that coated substrate film 82 moves in concert with the exterior drum section while curable liquid layer 84 is cured by ultraviolet radiation emanating from the ultraviolet light source. Curing energy sources 94-100 remain stationary during the rotation of exterior drum section 122. In a refinement, exterior drum section 122 rotates at a rate from about 4 to 240 rpm. Typically, the curing of curable liquid layer 84 is from about 0.1 to about 10 seconds.

In another embodiment, a method for forming an emboss pattern on a storage tape component is provided. The method of the present embodiment utilizes the systems set forth above. The method includes a step of contacting embossing drum 92 with a storage tape component. Characteristically, embossing drum 92 has exterior drum section 122 and an interior cavity 124. The exterior drum section 122 is transparent to ultraviolet light while the outer surface has a pattern that is complementary to an emboss pattern to be formed on the storage tape. The exterior drum section 122 is rotatable about a center such that the storage tape moves in concert with the exterior drum section 122. The method further includes a step of curing the curable layer with ultraviolet radiation emanating from the ultraviolet light source to form an embossed storage tape.

As set forth above, various embodiments of the present invention advantageously utilize a curable liquid composition that is polymerized. The curable liquid is selected from the group consisting of fluids that crosslink in the presence of UV and have a viscosity from about 2 to 20 centerpoise (cps) at 25° C. Advantageously, the curable liquid composition has a viscosity less than about 50 cps at 25° C. In another refinement, the curable liquid composition has a viscosity less than about 30 cps at 25° C. In another refinement, the curable liquid composition has a viscosity less than about 20 cps at 25° C. In another refinement, the curable liquid composition has a viscosity less than about 10 cps at 25° C. Typically, the curable liquid composition has a viscosity greater than about 2 cps at 25° C. In another refinement, the curable liquid composition has a viscosity greater than about 5 cps at 25° C. In a refinement, the curable liquid composition includes one or more acrylates. Examples of suitable acrylates include, but are not limited to, epoxy acrylates, urethane acrylates, polyester acrylates, polyether acrylates, acrylic acrylates, and the like. Such acrylates can be monoacrylates, diacrylates, higher order functionality acrylates, and combinations thereof. In a refinement, the polymerizable component(s) are present in an amount from about 90 to about 99 weight percent of the total weight of the curable liquid composition. In another refinement, the polymerizable component(s) are present in an amount from about 93 to about 99 weight percent of the total weight of the curable liquid composition. In still another refinement, the polymerizable component(s) are present in an amount from about 95 to about 99 weight percent of the total weight of the curable liquid composition.

The curable liquid composition further includes a free radical photoinitiator. Suitable free radical photoinitiators include, but are not limited to, benzophenones, acetophenone derivatives, and combinations thereof. Specific examples include alpha-hydroxyalkylphenylketones, benzoins (e.g., benzoin alkyl ethers and benzyl ketals), monoacylphosphine oxides, bisacylphosphine oxides, and combinations thereof. A particularly useful photoinitiator is Bis(2,4,6-trimethylbenzoyl)-phenylphosphineoxide. In a refinement, the free radical photoinitiatior is present in an amount from about 0.1 to about 10 weight percent of the total weight of the curable liquid composition. In another refinement, the free radical photoinitiatior is present in an amount from about 0.5 to about 8 weight percent of the total weight of the curable liquid composition. In still another refinement, the free radical photoinitiatior is present in an amount from about 1 to about 5 weight percent of the total weight of the curable liquid composition.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A system for embossing a pattern on a storage tape, the system comprising:
a storage tape component having a curable layer;
an ultraviolet light source an embossing drum having an exterior drum section and an interior cavity, the exterior drum section being transmissive to ultraviolet light, the exterior section having an outer surface that contacts the curable layer, the outer surface having a first pattern that is complementary to a second pattern to be formed on the storage tape component, the exterior drum section rotatable about a center such that the storage tape component moves in concert with the outer drum section while the curable layer is cured by ultraviolet radiation emanating from the ultraviolet light source.

2. The system of claim 1 wherein the ultraviolet light source is stationary with respect to the exterior drum section during operation of the system.

3. The system of claim 1 wherein the second pattern includes a plurality tracks.

4. The system of claim 3 wherein each track includes a plurality of ridges and trenches.

5. The system of claim 1 wherein at least a section of the tracks are wobbled.

6. The system of claim 1 wherein the curable layer includes a photocurable monomer.

7. The system of claim 6 wherein the photocurable monomer is selected from the group consisting of fluids that crosslink in the presence of UV and have a viscosity from about 2 to 20 centerpoise at 25° C.

8. The system of claim 1 wherein the storage tape component further includes a base-film, the curable layer disposed on and contacting the base-film.

9. The system of claim 1 wherein the storage component further includes a back-coating disposed over the base-film.

10. The system of claim 9 wherein the base-film comprises a polyester.

11. The system of claim 1 wherein the exterior drum section comprises a component selected from the group consisting of quartz, UV transparent polymers, and combinations thereof.

12. A method for forming an emboss pattern on a storage tape component having a curable layer disposed thereon, the method comprising:
contacting an embossing drum with the storage tape component, the embossing drum having an exterior drum section and an interior cavity, the exterior drum section being transparent to ultraviolet light, the outer surface having a pattern that is complementary to an emboss pattern to be formed on the storage tape component, the exterior drum section rotatable about a center such that the storage tape component moves in concert with the outer drum section; and
curing the curable layer with ultraviolet radiation emanating from the ultraviolet light source to form the embossed pattern on the storage tape component.

13. The method of claim 12 wherein the second pattern includes a plurality tracks.

14. The method of claim 13 wherein each track includes a plurality of trenches and ridges.

15. The method of claim 12 wherein at least a portion of the tracks are wobbled.

16. The method of claim 12 wherein the curable layer includes a photocurable monomer.

17. The method of claim 16 wherein the photocurable monomer is selected from the group consisting of fluids that crosslink in the presence of UV and have a viscosity from about 2 to 20 centerpoise at 25° C.

18. The system of claim 12 wherein the storage tape component further includes a base-film, the curable layer disposed on and contacting the base-film.

19. The method of claim 12 wherein the storage tape component further includes back-coating disposed over the base-film.

20. The system of claim 12 wherein the exterior drum section comprises a component selected from the group consisting of quartz, UV transparent polymers, and combinations thereof.
